(19) United States
(12) Patent Application Publication
(10) Pub. No.: US 2015/0296297 A1
(43) Pub. Date: Oct. 15, 2015

(54) ANC ACTIVE NOISE CONTROL AUDIO HEADSET WITH REDUCTION OF THE ELECTRICAL HISS

(71) Applicant: PARROT, Paris (FR)

(72) Inventors: Phong Hua, Paris (FR); Vu Hoang Co Thuy, Paris (FR); Pierre Guiu, Paris (FR)

(21) Appl. No.: 14/677,842

(22) Filed: Apr. 2, 2015

(30) Foreign Application Priority Data
Apr. 11, 2014 (FR) 1453284

(51) Int. Cl. H04R 3/00; H04R 1/10

(52) U.S. Cl. CPC H04R 3/002; H04R 1/10

(57) ABSTRACT

The headset includes an active noise control system, with an ANC microphone delivering a signal including an acoustic noise component. A digital signal processor DSP (50) comprises a feedback ANC branch (54) applying a filtering transfer function (H_{FB}) to the signal picked up by the ANC microphone, and means (46) for mixing the signal of the feedback branch with an audio signal to be reproduced (M). The ANC microphone is an internal microphone (28) placed inside the acoustic cavity (22), and the feedback ANC filter (54) is one between a plurality of selectively switchable, pre-configured feedback ANC filter. The DSP (50) comprises means (62) for verifying whether current characteristics of the microphone signal fulfil or not a set of predetermined criteria, and for selecting one of the pre-configured feedback ANC filters as a function of the result of this verification. The filtering (H_{EQ}) of an equalization branch (58) of the signal to be reproduced (M) is also modified as a function of the current selected feedback ANC filter.

The invention relates to an audio headset comprising an “active noise control” system.

Such a headset may be used for listening an audio source (music for example) coming from an apparatus such as MP3 player, radio, smartphone, etc., to which it is connected by a wireline connection or by a wireless connection, in particular a Bluetooth link (registered trademark of Bluetooth SIG).

If provided with a microphone set adapted to pick up the voice of the headset wearer, this headset may also be used for functions of communication such as “hands-free” telephony functions, as a complement of the audio source listening. The headset transducer then reproduces the voice of the remote speaker with which the headset wearer is in conversation.

The headset generally comprises two earphones linked by a headband. Each earphone comprises a closed casing housing a sound reproduction transducer (simply called “transducer” hereinafter) and intended to be applied around the user's ear with interposition of a circumaural pad isolating the ear from the external sound environment.

There also exists earphones of the “intra-aural” type, with an element to be placed in the ear canal, hence having no pad surrounding or covering the ear. In the following, it will mainly be referred to earphones of the “headset” type with a transducer housed in a casing surrounding the ear (“circumaural” headset) or in rest on the latter (“supra-aural” headset), but this example must not be considered as being limitative, as the invention can also be applied, as will be understood, to intra-aural earphones.

When the headset is used in a noisy environment (metro, busy street, train, plane, etc.), the wearer is partially protected from the noise by the headset earphones, which isolate him thanks to the closed casing and to the circumaural pad.

However, this purely passive protection is only partial, as a portion of the sounds, in particular in the low portion of the frequency spectrum, can be transmitted to the ear through the earphones casing, or via the wearer's cranium.

That is why so-called “Active Noise Control” or ANC techniques have been developed, whose principle consists in picking up the incident noise component and in superimposing, temporally and spatially, to this noise component an acoustic wave that is ideally the inverted copy of the pressure wave of the noise component. The matter is to create that way a destructive interference with the noise component and to reduce, ideally neutralize, the variations of pressure of the spurious acoustic wave.

The EP 2 597 889 A1 (Parrot) describes such a headset, provided with an ANC system combining closed-loop feedback and open-loop feedforward filtering types. The feedback filtering path is based on a signal collected by a microphone placed inside the acoustic cavity delimited by the earphone casing, the circumaural pad and transducer. In other words, this microphone is placed near the user's ear, and receives mainly the signal produced by the transducer and the residual noise signal, not neutralized, still perceptible in the front cavity. The signal of this microphone, from which is subtracted the audio signal of the music source to be reproduced by the transducer, constitutes an error signal for the feedback loop of the ANC system. The feedforward filtering path uses the signal picked up by the external microphone collecting the spurious noise existing in the immediate environment of the headset's wearer. Finally, a third filtering path processes the audio signal coming from the music source to be reproduced. The output signals of the three filtering paths are combined and applied to the transducer to reproduce the music source signal associated to a surrounding noise suppression signal.

The existing ANC systems suffer from a limitation due to the presence of an “electrical hiss”, perceived when the ANC system is activated: indeed, the feedback microphone provides an electrical signal that is the image of the acoustic signal and that is accompanied by a low electrical noise, and the amplification by the ANC filter, which is typically of the order of 20 to 30 dB, increases this electrical noise. Moreover, the noise picked up by the microphone is increased by the undesirable so-called waterbed effect: beyond the main frequency band of noise suppression, the noise is amplified in a relatively narrow frequency band, generally about 1 kHz, in a perfectly perceptible and of course harmful manner. If too significant, this phenomenon may even generate a Larsen effect, a phenomenon that may be observed for many headsets when the pad is accidentally removed. These phenomena create on the transducer a noise that may sometimes be more audible and more annoying than the noise to be suppressed, in particular when the latter is low.

Concretely, the attenuation of the noises in the low frequencies is all the more better that the gain of the feedback ANC filter is high, but in compensation the hiss increases. It is hence desirable to adapt the gain of the feedback ANC filter as a function of the ambient noise: if this ambient noise is low, a lesser ANC gain and/or a gain producing less waterbed effect is needed. The filter will then be less efficient, but the hiss will also be reduced. Conversely, in case of strong ambient noise, a high ANC gain is preferable, because the electrical hiss generated becomes negligible with respect to the ambient noise.

The WO 2010/129219 A1 (EP 2 425421 A0) describes an ANC system of the adaptive type, i.e. using filters whose transfer function is dynamically and continuously modified by an algorithm for analysing the signal in real time. An external microphone placed on the casing of the headset earphones collects the ambient noises, whose level is analysed to adjust the transfer function of the feedback filter.

The drawback of this method lies in that the feedback ANC does not adapt to the noise really perceived by the user, but to the noise existing in the external environment of the headset. Now, the noise really perceived may be modified by the acoustic leakages, different from one individual to another as a function of the positioning of the headset on the head, of the shape of the user's ear, of the different tightenings of the headset on the head, of the presence of hairs at the place where the circumaural pads come in rest, etc. When acoustic leakages are present, the ANC efficiency is reduced, so that, to suppress more noise, it would be required to increase the ANC gain, with, consequently, a higher level of electrical hiss.

The EP 1 923 864 A2 describes an ANC system that comprises an internal microphone, placed inside the acoustic ear cavity of the headset earphone, and that pilots the feedback branch of the noise reducer. The picked-up signal is analysed in several frequency bands during periods of silence in the music, or during periods where the music is placed in forced rest by the ANC system. The filter coefficients are modified as a function of the result obtained, so as to adapt at best the response curve of this filter as a function of the characteristics of the picked-up signal. The proposed technique of noise reduction provides only a limited result on the reduction of the electrical hiss and waterbed effect phenomena. Above all, the switchings between the different transfer functions are particularly perceptible by the user, all the more that they take place during periods of silence of the audio signal to be reproduced.

Taking into account what precedes, the object of the invention is to propose a new ANC noise reduction technique:
which provides a significant reduction of the electrical hiss phenomenon;
with no degradation of the anti-noise performance of the ANC system, i.e. the residual noise perceived by the user will always be reduced at best, with in particular i) a strong attenuation of the low frequencies and ii) a wide suppression frequency bandwidth;
in the manner the most imperceptible possible for the headset wearer when the filtering changes are operated;
the whole, without the audio signal coming from the music source (or the remote speaker voice, in an application of telephony) be distorted, and without the spectrum of this signal is amputated by the ANC processing—although the noise neutralization signal and the audio signal to be reproduced are amplified by the same channel and reproduced by the same transducer.

To achieve these objects, the invention proposes an audio headset with an ANC active noise control system comprising, in a manner known per se from the above-mentioned EP 1 923 864 A2:
an internal ANC microphone, placed inside the acoustic ear cavity of the headset earphone, adapted to deliver a signal picked up in this cavity; and
a digital signal processor, DSP, comprising:
   a closed-loop feedback branch, comprising a feedback ANC filter adapted to apply a filtering transfer function to the signal picked up by the ANC microphone, the feedback ANC filter being one between a plurality of selectively switchable, pre-configured feedback ANC filters;
   means for analysing in real time the signal picked up by the ANC microphone, adapted to verify if current characteristics of this signal, comprising values of energy of the signal in a plurality of frequency bands, fulfil a set of predetermined criteria;
   selection means, adapted to select one of the pre-configured feedback ANC filters as a function of the result of the verification of the set of criteria performed by the analysis means; and
   mixing means, receiving as an input the signal delivered by the feedback branch at the output of the feedback ANC filter as well as an audio signal to be reproduced, and delivering as an output a signal adapted to pilot the transducer.
Characteristically of the invention, the DSP further comprises:
   an equalization branch, comprising an equalization filter adapted to apply an equalization transfer function to the audio signal to be reproduced before application of the latter to the mixing means, the equalization means being one between a plurality of selectively switchable, pre-configured equalization filters.

Moreover, the selection means are means adapted to select simultaneously:
i) one of the pre-configured feedback ANC filters as a function of the result of the verification of said set of criteria; and
ii) one of the pre-configured equalization filters, as a function of the current selected feedback ANC filter.

In a preferential embodiment, the set of predetermined criteria further comprises the detection of the presence or not of said audio signal to be reproduced, and the predetermined criteria comprise two different series of respective thresholds to which are compared said values of energy, either one of the two series being selected according to whether an audio signal to be reproduced is present or not.

Advantageously, the headset can further comprise an external microphone, placed outside the acoustic cavity and adapted to pick up an acoustic noise existing in the environment of the headset, the DSP then including an open-loop feedforward branch, comprising a feedforward ANC filter adapted to apply a feedforward filtering transfer function to the signal delivered by the external microphone. The feedforward ANC filter is one between a plurality of selectively switchable, pre-configured feedforward ANC filter, and the selection means are also adapted to select one of the pre-configured feedforward ANC filters as a function of the current selected feedback ANC filter.

An example of embodiment of the invention will now be described, with reference to the appended drawings in which the same references denote identical or functionally similar elements throughout the figures.

FIG. 1 generally illustrates an audio headset on the head of a user.

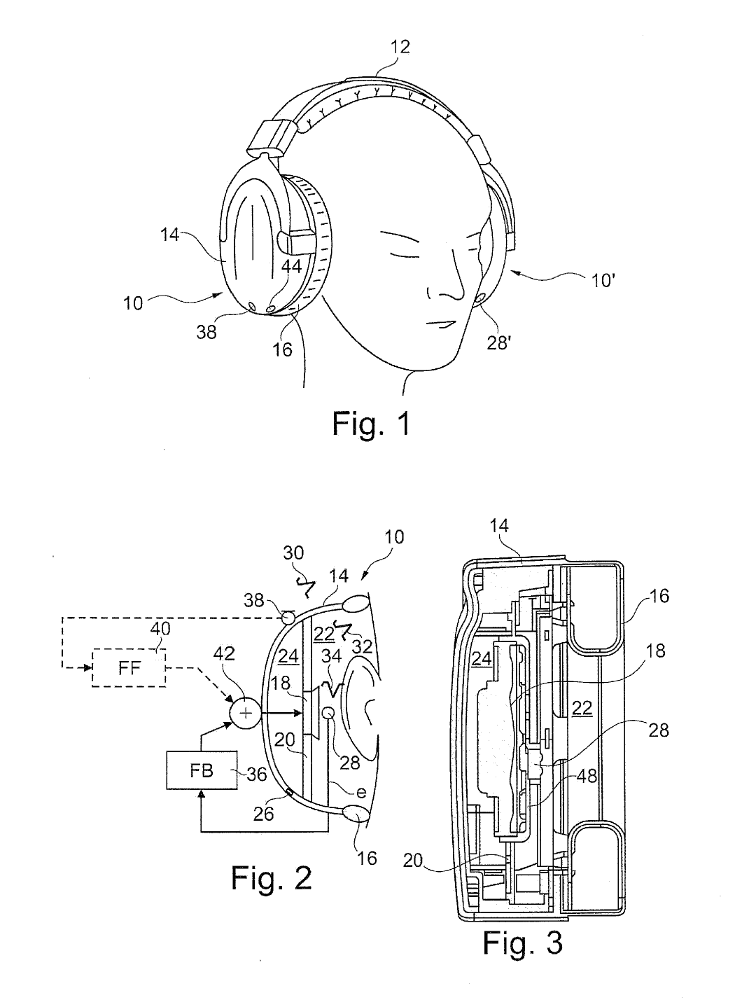

FIG. 2 is a schematic representation showing the different acoustic and electrical signals as well as the various functional blocks implied in the operation of an active noise control audio headset.

FIG. 3 is an sectional view in elevation of one of the earphones of the headset according to the invention, showing the configuration of the various mechanical elements and electromechanical members thereof.

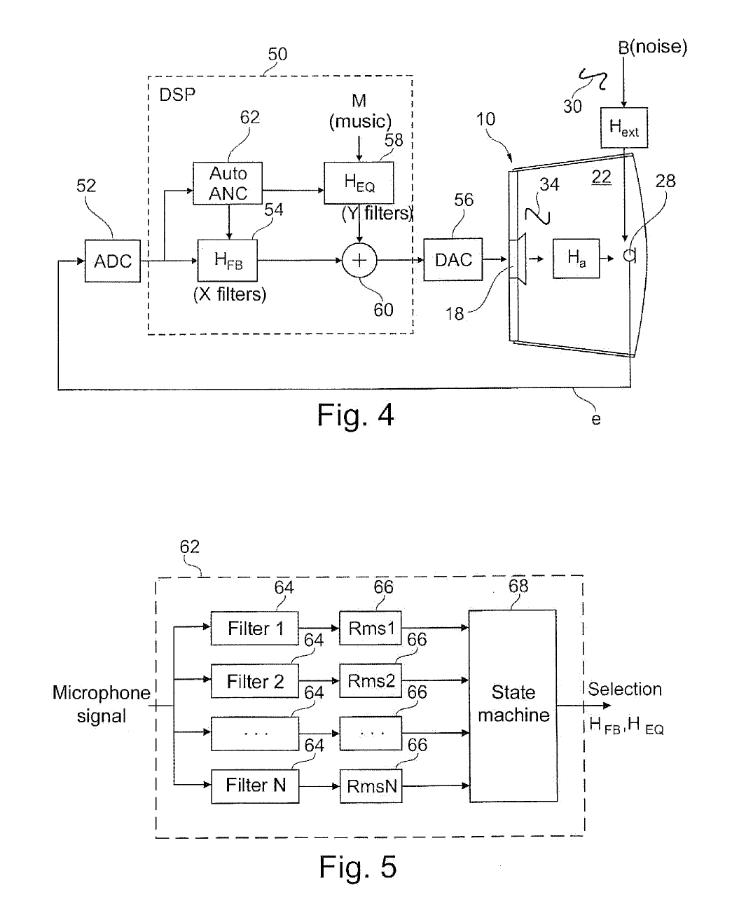

FIG. 4 schematically illustrates, as operational blocks, the way the denoising processing according to the invention is performed.

FIG. 5 illustrates more precisely the elements implementing the function of analysis of the microphone signal and of selection of the filters to be applied to the signals delivered to the headset transducer.

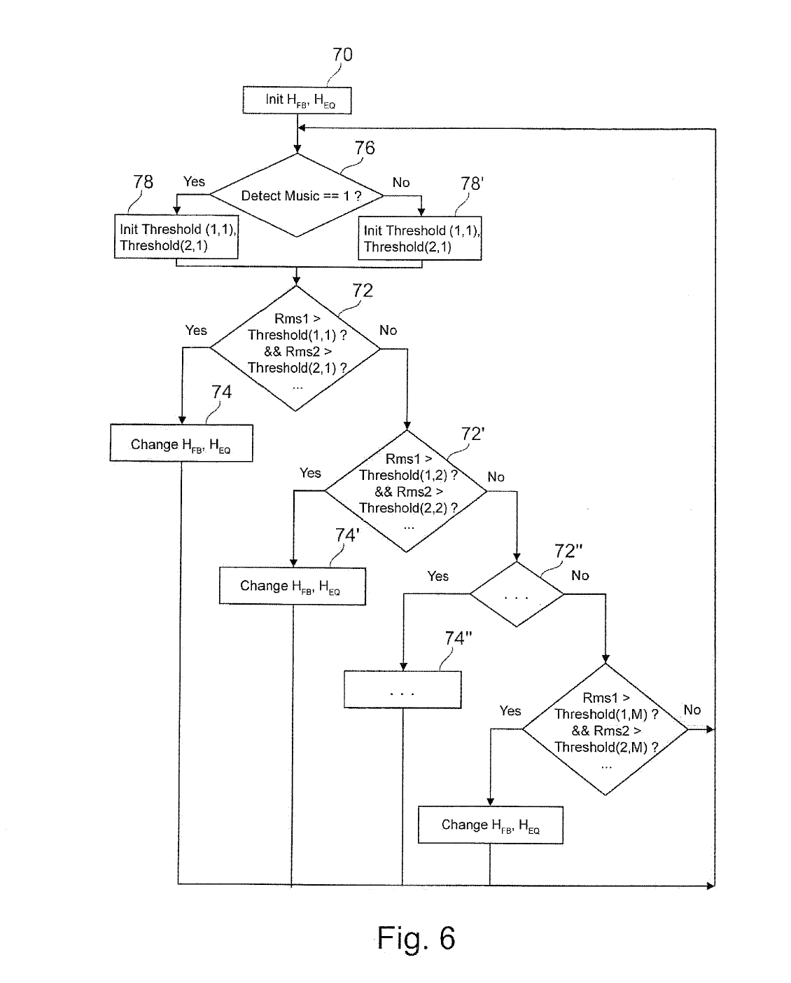

FIG. 6 is a flow chart describing the operation of the state machine of the function of analysis and selection of FIG. 5.

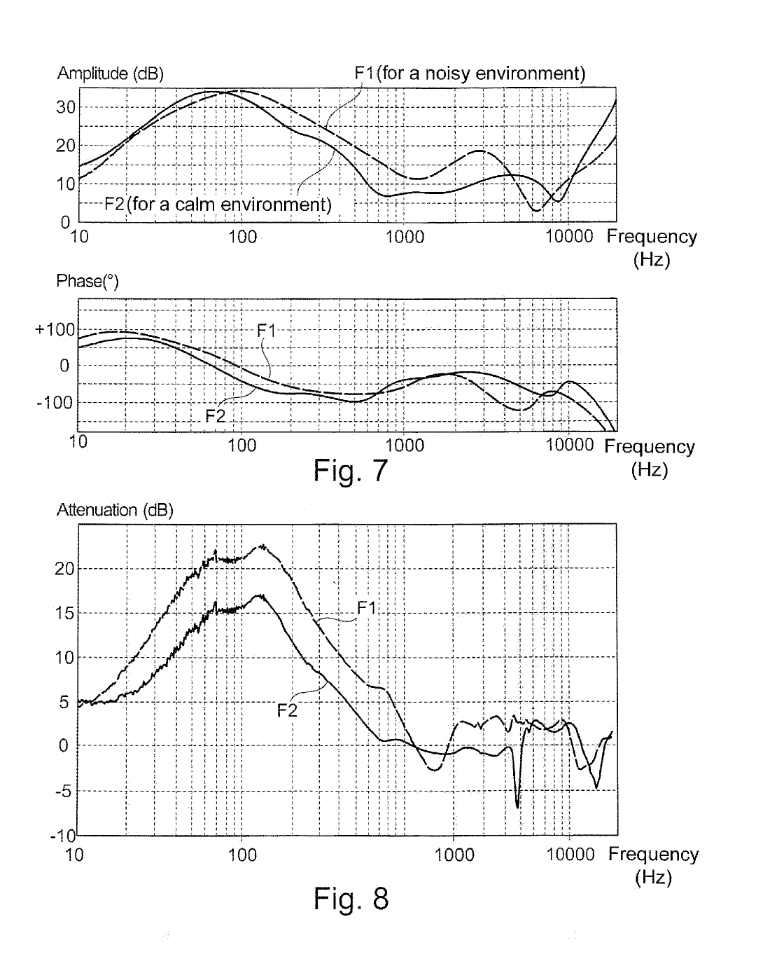

FIG. 7 shows, in amplitude and phase, the Bode diagram of the transfer function of two ANC filters alternately selected in an automatic manner as a function of the external noise conditions.

FIG. 8 illustrates examples of attenuation obtained with the two filters exemplified in FIG. 7.

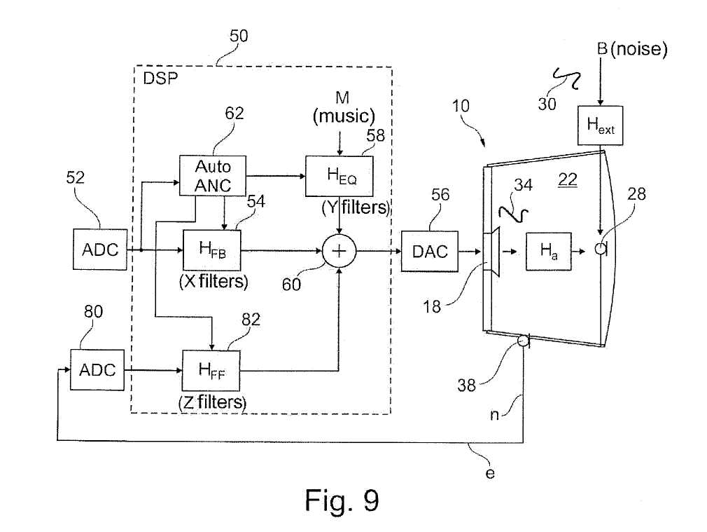

FIG. 9 is similar to FIG. 4, for a system including a feedforward branch in addition to the feedback branch.

In FIG. 1 is shown an audio headset placed on the head of the user thereof. This headset includes, in a manner conventional per se, two earphones 10, 10′ linked by a holding headband 12. Each of the earphones 10 comprises an external casing 14 coming on the user's ear contour, with interposition between the casing 14 and the ear periphery a circumaural flexible pad 16 intended to ensure a satisfying tightness, from the acoustic point of view, between the ear region and the external sound environment. As indicated in introduction, this example of configuration of the “headset” type with a transducer housed in a casing surrounding the ear or in rest on the latter must not be considered as being limitative, as the invention can also be applied to intra-aural earphones comprising an element to be placed in the ear canal, hence earphones devoid of casing and pad surrounding or covering the ear.

FIG. 2 is a schematic representation showing the different acoustic and electrical signals as well as the various operational blocks involved in the operation of an active noise control audio headset.

The earphone 10 encloses an sound reproduction transducer 18, hereinafter simply called “transducer”, carried by a partition 20 defining two cavities, i.e. a front cavity 22 of the ear side and a rear cavity 24 on the opposite side.

The front cavity 22 is defined by the inner partition 20, the wall 14 of the earphone, the pad 16 and the external face of the user's head in the ear region. This cavity is a closed cavity, except the inevitable acoustic leakages in the region of contact of the pad 16. The rear cavity 24 is a closed cavity, except for an acoustic vent 26 allowing to obtain a reinforcement of the low frequencies in the front cavity 22 of the earphone.

Finally, for the active noise control, an internal microphone 28 is provided, placed the closest possible to the ear canal, to pick-up the residual noise present in the internal cavity 22, a noise that will be perceived by the user. Leaving aside the audio signal of the music source reproduced by the transducer (or the remote speaker voice, in an application of telephony), the acoustic signal picked up by this internal microphone 28 is a combination:
of the residual noise 32 coming from the transmission of the surrounding external noise 30 through the earphone casing 14, and
a sound wave 34 generated by the transducer 18, which is, ideally according to the principle of the destructive interferences, the inverted copy of the residual noise 32, i.e. of the noise to be suppressed at the listening point.

The noise neutralization by the sound wave 34 being never perfect, the internal microphone 28 collects a residual signal that is used as an error signal e applied to a closed-loop feedback filtering branch 36.

Potentially, an external microphone 38 may be placed on the casing of the headset earphones, to pick up the surrounding noise outside the earphone, schematised by the wave 30. The signal collected by this external microphone 38 is applied to a feedforward filtering stage 40 of the active noise control system. The signals coming from the feedback branch 36, and, if present, from the feedforward branch 40, are combined in 42 to pilot the transducer 18.

Furthermore, the transducer 18 receives an audio signal to be reproduced coming from a music source (Walkman, radio, etc.), or the remote speaker voice, in an application of telephony. As this signal undergoes the effects of the closed loop that distorts it, it will have to be pre-processed by an equalization so as to have the desired transfer function, determined by the gain of the open loop and the target response with no active control.

The headset may possibly carry, as illustrated in FIG. 1, another external microphone 44 intended for communication functions, for example if the headset is provided with “hands-free” telephony functions. This additional external microphone 44 is intended to pick up the voice of the headset wearer, it does not intervene in the active noise control, and, in the following, it will be considered as an external microphone potentially used by the ANC system only the microphone 38 dedicated to the active noise control.

FIG. 3 illustrates, in a sectional view, an exemplary embodiment of the different mechanical and electroacoustic elements schematically shown in FIG. 2 for one of the earphones 10 (the other earphone 10′ being made identical). We can see therein the partition 20 dividing the inside of the casing 14 into a front cavity 22 and a rear cavity 24 with, mounted on this partition, the transducer 18 and the internal microphone 36 carried by a grid 48 holding the latter close to the ear canal of the user.

FIG. 4 schematically illustrates, as operational blocks, the ANC active noise control system according to the invention.

It is an ANC system of the digital type, implemented by a digital signal processor DSP 50. It will be noted that, although these schemes are presented as interconnected circuits, the implementation of the different functions is essentially software-based, this representation being only illustrative.

We can also see therein the feedback branch 36 whose principle has been described hereinabove with reference to FIG. 2, with digitization by means of an ADC converter 52 of the error signal e picked up by the internal microphone 28. The digitized error signal is processed by a filter 54, then converted into an analog signal by the DAC 56, so as to be rendered by the transducer 18 in the cavity of the earphone 10. The reproduced signal is possibly combined to a music signal M that, after equalization 58, is combined in 60 to the noise cancelling signal, for conversion by the DAC 56 and reproduction by the transducer 18.

The block 54 defining the transfer function of the feedback branch includes a plurality of configurations of selectively switchable, predetermined filters, each of these X filters allowing to obtain a more or less strong attenuation of the ambient noise, to the detriment of an also more or less strong electrical hiss, with a smart mechanism of swapping between the X filters as a function of the signal picked up by the internal microphone 28.

In this respect, it is important that the swapping between the different selectable filters is operated based on the signal picked up by the internal microphone 28, because this is that latter (and not the external microphone 38), close to the user's ear, that provides the ANC system with an image of the residual really perceived by the user, taking in particular into account the potential acoustic leakages between the inside and the outside of the earphone casing.

The switching between the different filters of the feedback branch, allowing to optimize the attenuation/hiss compromise, will hence depend on the spectral level and content inside the front cavity 22 of the headset earphone.

It will be moreover noted that the choice of a digital system allows to easily program a high number of filters (unlike an analog system, in which a great number of electronic components would be necessary to have this equivalence), and above all to be able to integrate an algorithmic intelligence allowing to analyze the signal in real time and to switch with a very short time of response that of the filters which will provide the better attenuation/hiss compromise.

The analysis of the error signal picked up by the microphone 28 is performed in the DSP 50 by an “Auto-ANC” module 62, which analyses the signal e and defines which one of the X filters of the feedback branch 54 it is advisable to select, and likewise, which one of the Y filters of the music signal equalization branch 58 it is advisable to select (wherein Y can be, but not necessarily, equal to X).

More precisely, the signal e picked up by the internal microphone 28 (that is supposed to be identical to the signal picked up by the ear of the headset user) is (in the configuration of FIG. 4) given by:

e=Hₑₓₜ/(1−Hₐ*H_{FB})*B+Hₐ/(1−Hₐ*H_{FB})*H_{EQ}*M
B being the external noise signal 30,
M being the input music signal,
Hₑₓₜ being the transfer function between an external noise source and the internal microphone 28,
H_{FB} being the transfer function of the feedback filter 54,
H_{EQ} being the transfer function of the equalization filter 58, and
Hₐ being the transfer function between the transducer 18 and the internal microphone 28.

In this equation, it can be observed that a music signal played is subjected to a transfer function:

Hₐ/(1−Hₐ*H_{FB})*H_{EQ}

so that, if the filter H_{FB} of the feedback ANC branch 54 is modified, the perception of the music is also modified. Hence, in order for the perception of the music to remain the same for the user, the Auto-ANC control algorithm 62 will also have to modify the filter H_{EQ} of the music equalization branch 58 at the same time as that of the feedback ANC branch 54.

In other words, the switching, by the auto-ANC algorithm 62, of one of the X filters of the feedback ANC branch 54 will be simultaneously accompanied with the switching of one of the Y filters of the music equalization branch 58 to re-equilibrate the effects of the filtering, of course if a music signal is present.

FIG. 5 illustrates more precisely the elements implemented by the auto-ANC block 62 for the analysis of the signal and the selection of the feedback ANC filters and the equalization filters.

The digitized signal e collected by the internal microphone 28 is subjected to a frequency decomposition by a set of filters 64 so as to calculate in 66 the energy Rmsᵢ of this signal e in each of its N frequency components.

Within the framework of an active noise control by an audio headset, the study of the “colour” of the surrounding noise via the spectrum analysis thereof allows to discriminate various significant situations: for example, for a use of the headset in a noisy environment of the public transportation type (plane, train), the ratio between low and high frequencies is far more important than a calmer environment such as in an office. Hence, for example, Rms₁ may be the power of the microphone signal under 100 Hz, Rms₂ the power of the signal about 800 Hz, etc.

The obtained values Rms₁, Rms₂ Rms_{N} are applied to a state machine 68, which compares these values of energy to respective thresholds and determines as a function of these comparisons which one of the X filters of the feedback ANC branch 54, and as the case may be (if music is present), which one of the Y filters of the equalization branch 58, must be selected.

FIG. 6 illustrates more precisely how this state machine 68 operates.

The state machine 68 will decide, taking into account the current levels of energy Rms₁, Rms₂ . . . Rmsₙ, if it is required or not to modify the transfer functions H_{FB} and H_{EQ} as they are at the initial state (block 70). If those energies exceed respective predefined thresholds (test 72):

Rms₁>Threshold(1,1)&&Rms₂>Threshold(2,1)&& . . . &&Rms_{N}>Threshold(N,1),

then the algorithm considers that the external noise is strong enough to necessitate an adaptation of the filter H_{FB} and, in the same time, a possible corresponding adaptation of the equalization filter H_{EQ} for the music signal (block 74).

In the opposite case, i.e. if the preceding condition is not verified, a new comparison is performed (block 72′):

Rms₁>Threshold(1,2)&&Rms₂>Threshold(2,2)&& . . . &&Rms_{N}>Threshold(N,2),

with lower thresholds, i.e. Threshold(1,2)<Threshold (1,1), Threshold (2,2)<Threshold (2,1) . . . Threshold (N,2)<Threshold (N,1).

If the latter test is positive, then the filters H_{FB} and H_{EQ} are modified (block 74′), but with parameters that are different from the preceding case.

In the negative case, it is possible to continue iteratively in the same way (blocks 72″, 74″, etc.) with progressively lower thresholds, so as to choose, among the X filters able to be selected for the feedback branch 54, which one produces the less perceptible possible electrical hiss, while providing the better attenuation possible of the acoustic noise.

Very advantageously, upstream from this succession of tests, it is provided to detect (block 76) the presence or not of a music signal M in the rendering chain, for example by comparison of the power of the signal on the branch intended for this music signal, with respect to a predetermined threshold.

The initial thresholds are then adjusted to different values (blocks 78 or 78′) according to whether we are or not in presence of music, to take into account the fact that the music plays a role of masking, in the same way as the external noise, on the perception of the electrical hiss introduced by the ANC control.

FIGS. 7 and 8 illustrate examples of the two feedback ANC filters alternately selected in an automatic manner as a function of the external noise conditions: FIG. 7 shows, in amplitude and phase, the Bode diagram of the transfer function H_{FB} of these two filters, whereas FIG. 8 illustrates the corresponding attenuations obtained. It has be chosen for these two filters:
a first filter F1 adapted to the noisy environments such as public transportations, which strongly attenuate the very low frequencies with a higher gain in the medium and a wider attenuation bandwidth; and
a second filter F2 adapted to a calm environment, with a lesser ANC attenuation, a stronger reduction of the electrical hiss and a limitation of the waterbed effect about 1000 Hz.

FIG. 9 is a generalization of the invention to an ANC system comprising not only a feedback branch 54, but also a feedforward branch receiving as an input the signal n of an external microphone 38. This signal n, after digitization by the ADC 80, is subjected to a processing for applying thereto a transfer function H_{FF} (block 82), within the DSP 50.

As in the case of the feedback branch, the Auto-ANC algorithm 62 will modify the coefficients of the filter H_{FF}, i.e. select one among Z preconfigured digital filters (wherein Z can be, but not necessarily, equal to X), based on the signal delivered by the internal microphone 28—and not on the signal delivered by the external microphone 38. The equation of the signal e delivered by the internal microphone 38 is:

e=Hₐ*H_{FF}*B+Hₑₓₜ/(1−Hₐ*H_{FB})*B+Hₐ/(1−Hₐ*H_{FB})*H_{EQ}*M.

It will be noted that, in such a system, the feedforward filter H_{FF} has not influence on the equalization of the music, and that it is hence not necessary to modify the filter H_{EQ} of the equalization branch 58.

The state machine for the analysis of the signal e and the selection of the most suitable feedforward filter H_{FF} is the same as that illustrated in FIG. 6, the only difference being that, after the testing of the different thresholds (which remain the same) in the blocks 74, 74′, 74′ . . . , the transfer function H_{FF} is modified in addition to the transfer functions H_{FB} and H_{EQ}.

1. An audio headset, comprising two earphones (10) each including a transducer (18) for the sound reproduction of an audio signal to be reproduced, said transducer being housed in an ear acoustic cavity (22), said headset comprising an active noise control, ANC, system with:
an internal ANC microphone (28) placed inside the acoustic cavity (22), adapted to deliver a signal picked up in this cavity; and
a digital signal processor, DSP, (50), comprising:
a closed-loop feedback branch (36), comprising a feedback ANC filter (54) adapted to apply a filtering transfer function (H_{FB}) to the signal picked up by the ANC microphone, the feedback ANC filter (54) being one between a plurality of selectively switchable, preconfigured feedback ANC filters (F1, F2);
means (62) for analysing in real time the signal picked up by the ANC microphone, adapted to verify if current characteristics of this signal, comprising values of energy of the signal (Rms1, Rms2 . . . ) in a plurality of frequency bands (Filter1, Filter2), fulfil a set of predetermined criteria;
selection means (62), adapted to select one of the pre-configured feedback ANC filters (F1, F2) as a function of the result of the verification of the set of criteria performed by the analysis means; and
mixing means (46), receiving as an input the signal delivered by the feedback branch at the output of the feedback ANC filter (54) as well as an audio signal to be reproduced (1W), and delivering as an output a signal adapted to pilot the transducer (18),
characterized in that the DSP (50) further comprises:
an equalization branch, comprising an equalization filter (58) adapted to apply an equalization transfer function (H_{EQ}) to said audio signal to be reproduced (A4) before application of the latter to the mixing means (60), the equalization means (58) being one between a plurality of selectively switchable, pre-configured equalization filters,
and in that the selection means (62) are means adapted to select simultaneously:
i) one of the pre-configured feedback ANC filters (F1, F2) as a function of the result of the verification of said set of criteria; and
ii) one of the pre-configured equalization filters, as a function of the current selected feedback ANC filter.

2. The audio headset according to claim 1, wherein:
the set of predetermined criteria further comprises the detection (76) of the presence or not of said audio signal to be reproduced (M); and
the predetermined criteria comprise two different series of respective thresholds (Threshold(1,1), Threshold(2,1) . . . ) to which are compared said values of energy, either one of these two series being selected (78; 78′) according to whether an audio signal to be reproduced is present or not.

3. The audio headset according to claim 1, wherein:
the headset further comprises an external microphone (38), placed outside the acoustic cavity and adapted to pick up an acoustic noise (30) existing in the environment of the headset;
the DSP (50) further comprises:
an open-loop feedforward branch (40), comprising a feedforward ANC filter (82) adapted to apply a feedforward filtering transfer function (HFF) to the signal delivered by the external microphone (38);
the feedforward ANC filter is one between a plurality of selectively switchable, pre-configured feedforward ANC filter; and
the selection means are also adapted to select one of the preconfigured feedforward ANC filters as a function of the current selected feedback ANC filter.
